(19) United States
(12) Patent Application Publication
(10) Pub. No.: US 2014/0153277 A1
(43) Pub. Date: Jun. 5, 2014

(54) ASSEMBLING STRUCTURE FOR LED LAMP MODULE

(71) Applicant: Kuang-Chu LAI, New Taipei City (TW)

(72) Inventor: Kuang-Chu LAI, New Taipei City (TW)

(73) Assignee: Liang Meng Plastic Share Co., Ltd.

(21) Appl. No.: 13/689,813

(22) Filed: Nov. 30, 2012

(51) Int. Cl. F21V 17/10; F21V 29/00; F21V 21/30

(52) U.S. Cl. CPC F21V 17/10; F21V 21/30; F21V 29/002; F21V 29/2206
USPC 362/558; 362/427; 362/294

(57) ABSTRACT

An assembling structure of an LED lamp module includes an LED lamp base (10) and a heat sink (30). The LED lamp base (10) includes a plastic receptacle (11), an LED light source (12) disposed in the plastic receptacle (11), and a plurality of metal fasteners (20) spaced apart and upright on an outer side surface of the plastic receptacle (11). The heat sink (30) includes has a plurality of openings (42), wherein the LED lamp base (10) is rotatable with respect to the heat sink (30) to make the metal fasteners (20) positioned in the openings (42), respectively and thus, the LED lamp base (10) is combined with the heat sink (30).

### BACKGROUND OF THE INVENTION

1. Field of the Invention

The present invention relates to an LED lamp module, more particularly to an assembling structure of an LED lamp module.

2. Description of Related Art

Among the current lighting equipment, a light emitting diode (LED) which has advantages of low power consumption, power saving, long lifespan, compact size and quick response is replacing the traditional Tungsten filament lamps, fluorescent lamps, or mercury lamps and is widely used in various lighting modules.

In general, the higher power LEDs operate at, the more waste heat is generated. However, high temperature will greatly and adversely affect the lifespan and emitted efficiency of LEDs. Therefore, high power LED lamp modules are mostly equipped with heat dissipation structures to duly reduce the temperature. The LED lamp module of related art comprises an LED lamp base, a heat sink combined with the LED lamp base, and a power supply fixed on the heat sink. The power supply can supply the power to the LED module in the LED base.

The long lifespan of LEDs causes an increase in frequency of replacing the power supply. In order to replace the components or carry out maintenance, how to quickly assembly the LED lamp base from the heat sink becomes an issue the inventor greatly desires to deal with.

### SUMMARY OF THE INVENTION

An objective of the present invention is to provide an assembling structure of an LED lamp module to achieve the purpose of quickly assembling the LED lamp base and the heat sink.

Another objective of the present invention is to provide an assembling structure of an LED lamp module in order to replace the components of the lamp module and to carry out regular maintenance.

In order to achieve the above objectives, in an embodiment of the present invention, there is provided an assembling structure of an LED lamp module, comprising an LED lamp base and a heat sink. The LED lamp base comprises a plastic receptacle, an LED light source disposed in the plastic receptacle, and a plurality of metal fasteners spaced apart and upright on an outer side surface of the plastic receptacle. The heat sink has a plurality of openings, wherein the LED lamp base is rotatable with respect to the heat sink to make the metal fasteners positioned in the openings, respectively, and thus the LED lamp base is combined with the heat sink.

In a preferred embodiment of the present invention, the assembling structure of an LED lamp module further comprises a plurality of flexible members, wherein the heat sink comprises a positioning plate, the openings are formed on the positioning plate, the positioning plate further has a plurality of grooves interconnect with the openings and the flexible members are disposed in the respective grooves.

Compared with the related art, the present invention proposes a plurality of openings formed on the heat sink and a plurality of metal fasteners spaced apart and upright on the plastic receptacle of the LED lamp base. When the LED lamp base is rotated, the respective metal fasteners may slide and be positioned in the respective openings correspondingly. Thus, the LED lamp base can be combined with the heat sink without tedious process of related art of using screws and hand tools. The present invention can achieve the objective of quickly assembling the LED lamp base and the heat sink and improve the convenience and practicality.

### BRIEF DESCRIPTION OF DRAWING

FIG. 1 is a perspective view of the LED lamp module of the present invention;

FIG. 2 is an exploded perspective view of the LED lamp module of the present invention from one view;

FIG. 3 is an exploded perspective view of the LED lamp module of the present invention from another view;

FIG. 4 is an external schematic view of the LED lamp module of the present invention, before assembly;

FIG. 5 is an external schematic view of the LED lamp module of the present invention, before positioning;

FIG. 6 is a schematic plan view of the LED lamp module of the present invention, before assembly;

FIG. 7 is a schematic plan view of the LED lamp module of the present invention, after assembly;

FIG. 8 is a cross sectional side view of the LED lamp module of the present invention, after assembly; and

FIG. 9 is an external schematic view of the LED lamp module of the present invention, after assembly.

### DETAILED DESCRIPTION OF THE INVENTION

The detailed description and technology of the present invention will be described as follows with figures and description. However, the accompanying figures are provided only for reference and description, but not for limiting the present invention.

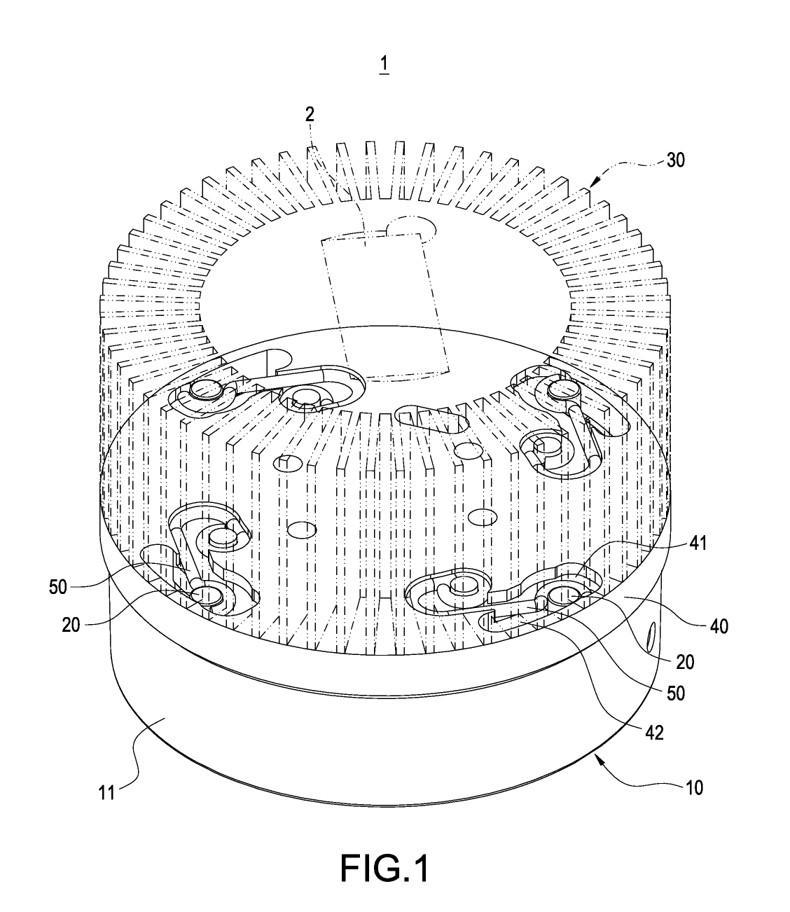

Please refer to FIG. 1, which is a perspective view of an assembling structure of an LED lamp module of the present invention. The present invention is an assembling structure of an LED lamp module 1, which mainly comprises an LED lamp base 10 and a heat sink 30. There are a plurality of openings 42 formed on the heat sink 30 and a plurality of metal fasteners 20 spaced apart and upright on the LED lamp base 10. In a preferred embodiment of the present invention, the LED lamp module 1 further comprises a plurality of flexible members 50, and the heat sink 30 further comprises a positioning plate 40. The positioning plate 40 is attached to the heat sink 30 and the openings 42 are formed on the positioning plate 40.

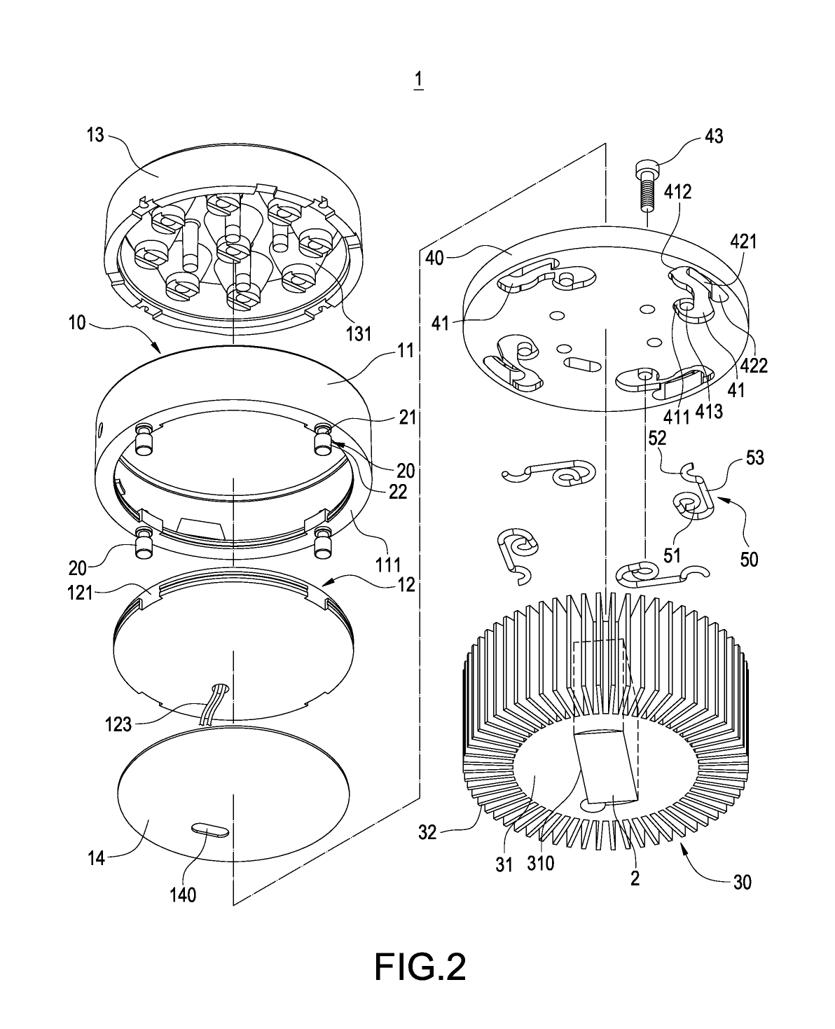

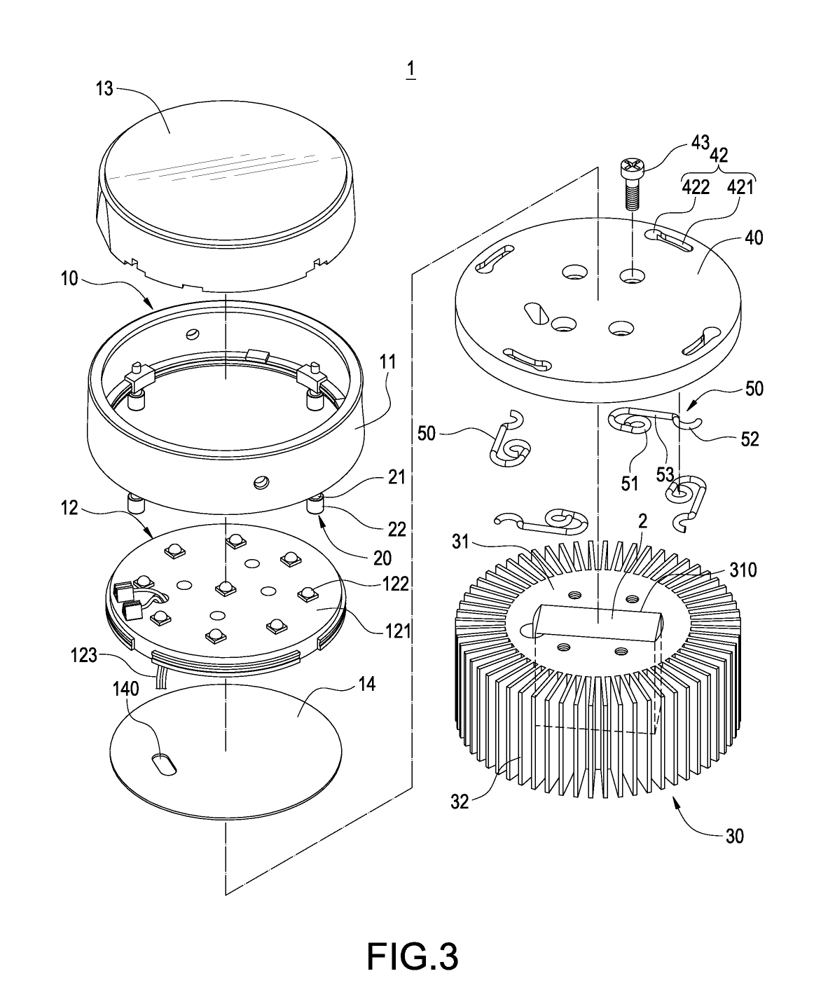

Please refer to FIGS. 2 and 3. They are exploded perspective views of the assembling structure of an LED lamp module of the present invention from two opposite sides. The LED lamp base 10 comprises a plastic receptacle 11, an LED light source 12 disposed in the plastic receptacle 11, a diffuser 13 attached to the plastic receptacle 11, an insulated plate 14, and a plurality of metal fasteners 20 spaced apart and upright on the outer side surface of the plastic receptacle 11 .

In a preferred embodiment of the present invention, the plastic receptacle 11 is a hollow ring. The LED light source 12 comprises a circuit board 121, a plurality of LEDs 122 disposed on the circuit board 121, and a wire 123 electrically connected to the circuit board 121, wherein the insulated plate 14 is provided with an aperture 140 through which the wire 123 is disposed. Also, the diffuser 13 covers the LED light source 12 and a plurality of light pipes 131 are formed on a side surface of the diffuser 13, the side surface is facing the LED light source 12. The insulated plate 14 is disposed on the side of the plastic receptacle 11 opposed to the diffuser 13 and is disposed between the LED light source 12 and the positioning plate 40. The metal fasteners 20 are spaced apart and upright on the outer side surface of the plastic receptacle 11; in the embodiment, the metal fasteners 20 are spaced apart on the end surface 111 of a side of the plastic receptacle 11 and the side is facing the heat sink 30. Each of the metal fasteners 20 comprises a support pin 21 fixed on the plastic receptacle 11 and a positioning rod 22 connecting to the end of the support pin 21; preferably, the support pin 21 is attached to the plastic receptacle 11 by insert-molding. The support pin 21 can be provided with a plurality of grooves; thus, the bonding strength between the support pin 21 and the plastic receptacle 11 can be enhanced during insert-molding.

During the assembling of LED lamp base 10 and the heat sink 30, the metal fasteners 20 slide in the openings 42 and the positioning rod 22 is constrained on one side of the flexible member 50. The positioning between the metal fastener 20 and the flexible member 50 will be described in detail later.

The heat sink 30 comprises a thermal conductor 31 and a plurality of fins 32 thermal-conductively connected to the thermal conductor 30. Preferably, the thermal conductor 31 is a cylinder and the fins 32 are spaced apart on and surrounding the outer edge surface of the thermal conductor 31. Moreover, a socket 310 is formed at the center of the thermal conductor 31.

A power supply 2 such as a power converter can be disposed in the socket 310, but the practical embodiment is not limited to this configuration.

A plurality of openings 42 are formed on the heat sink 30 to position the metal fasteners 20. In a preferred embodiment of the present invention, the heat sink 30 further comprises a positioning plate 40 attached to the thermal conductor 31 and the openings 42 are formed on the positioning plate 40. The detailed structures of the openings 42 are described later.

In the embodiment, a plurality of grooves 41 are further formed on the thermal conductor 31 and connecting to the respective openings 42. Besides, the grooves 41 are disposed on a side surface of the positioning plate 40 and the side surface is attached to the heat sink 30; each of the grooves 41 has an inner end 411 adjacent to the center of the positioning plate 40 and an outer end 412 adjacent to and facing the perimeter of the positioning plate 40. The openings 42 are connected to the outer ends 412 of the grooves 41 and penetrate the positioning plate 40. Each of the opening 42 comprises a limit hole 421 connecting to the outer end 412 of the groove 41 and an insertion hold 422 disposed at the end of the limit hole 421; the limit hole 421 extends and shrinks from a side of the insertion hole 422 inwards. Moreover, a projection 413 is disposed at the inner end 411 of each of the grooves 41 of the thermal conductor 31; one end of each flexible member is fastened at the projection 413 and the other end of the each flexible member 50 is partially exposed to the respective opening 42 with a free state.

The respective flexible members 50 are disposed in the respective grooves 41 and one end of each flexible member 50 is leaned against one side of each opening 42 and the metal fasteners 20 slide and are positioned in the respective openings 42 correspondingly. In the embodiment, the flexible member 50 is a wire spring; the flexible member 50 comprises a ring segment 51 looped around the projection 413, a hook segment 52 constraining the metal fastener 20, and an extension segment 53 connecting the ring segment 51 to the hook segment 52. It is worth mentioning that the openings 42 and grooves 41 can be formed directly on the thermal conductor 31. The openings 42 are used to position the metal fasteners 20 and the grooves 41 are for the disposition of the flexible members 50.

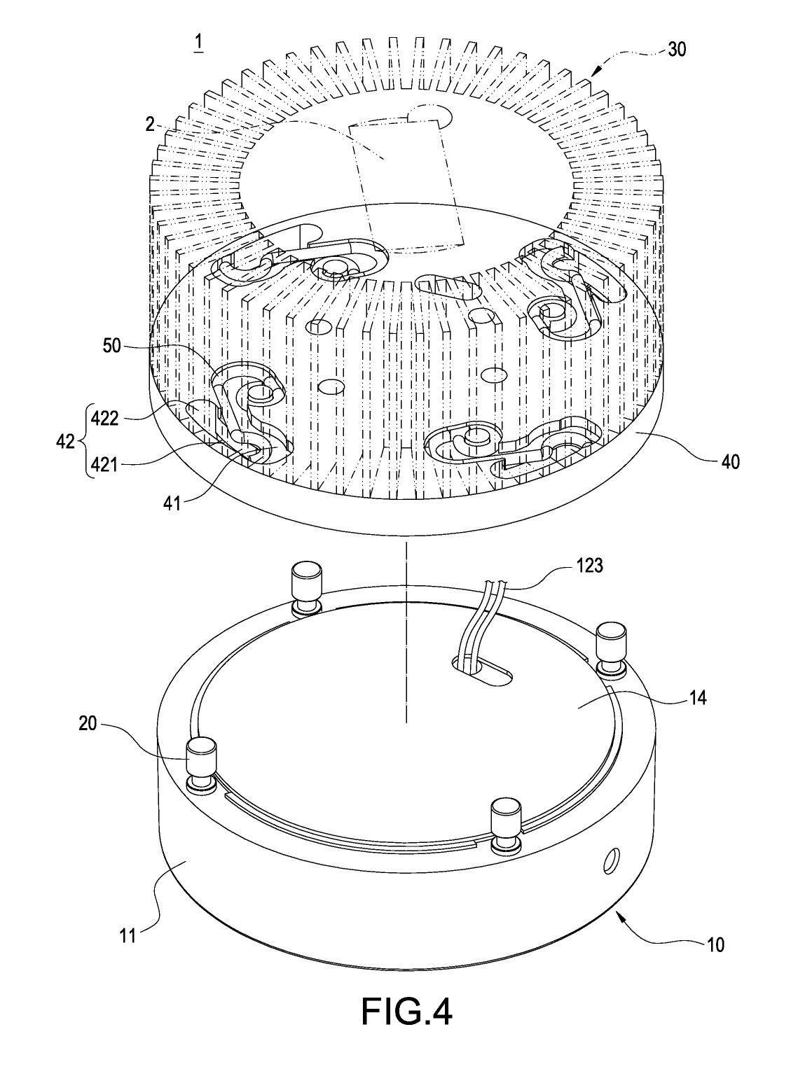

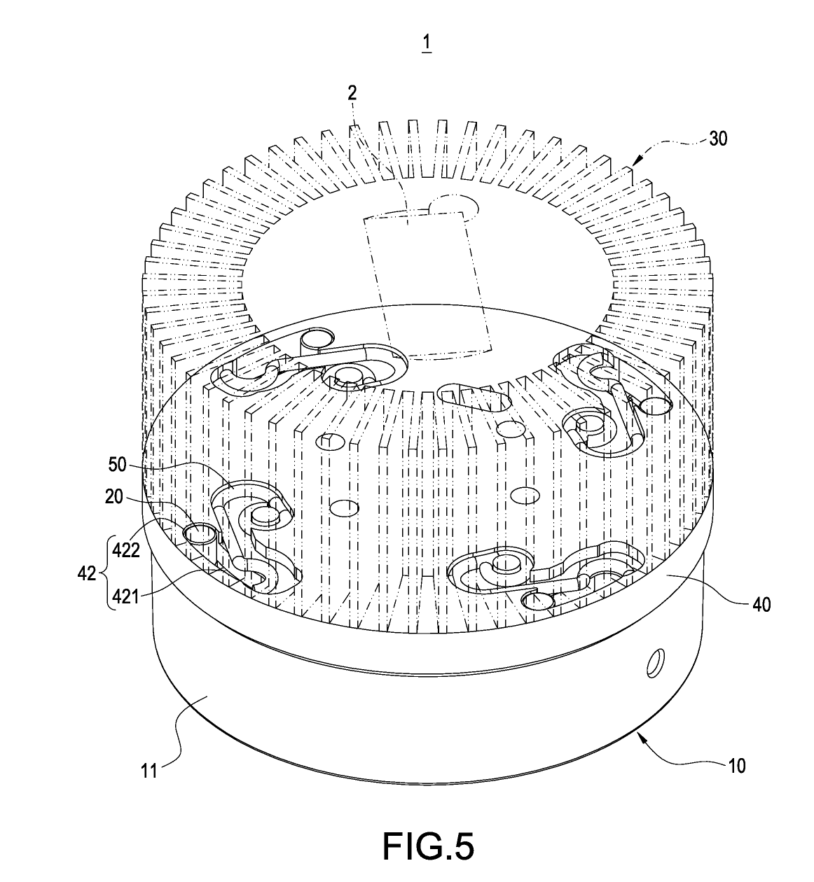

Please further refer to FIGS. 4 and 5. They are external schematic views of the LED lamp module of the present invention before assembly and before positioning, respectively. In a preferred embodiment, when the LED lamp module 1 is assembled, the respective flexible member 50 is installed into the respective groove 41 and then the positioning plate 40 is fastened on a side surface of the heat sink 30 by means of plural screws 43 (refer to FIGS. 2 and 3). After the positioning plate 40 is installed to the heat sink 30, viewed from the exterior, a plurality of openings 42 formed on the outer side surface of the positioning plate 40 away from the heat sink 30 is shown. On the other hand, on the LED lamp base 10, a plurality of metal fasteners 20 are spaced apart on the periphery of the end side of the LED lamp base 10.

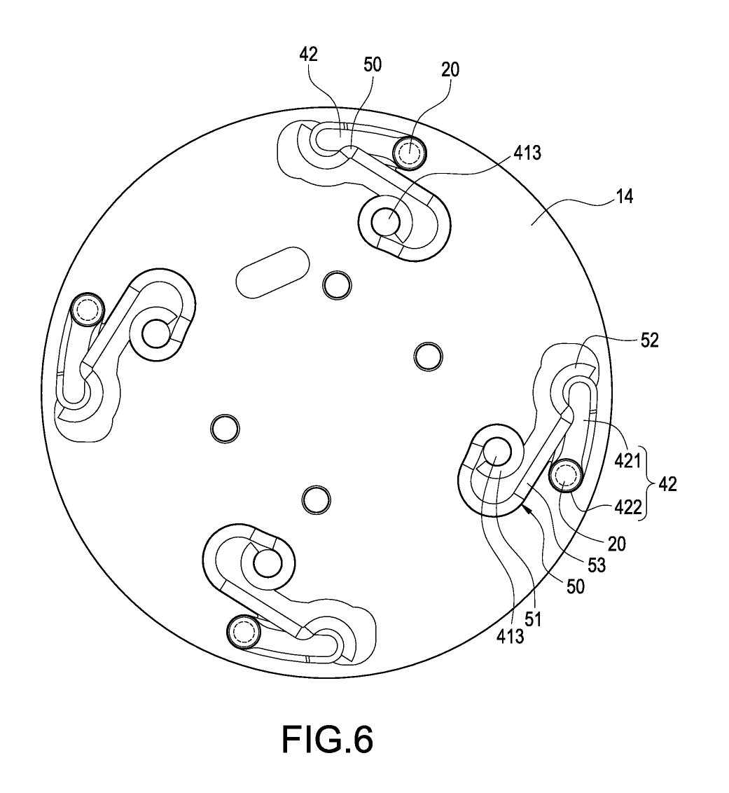

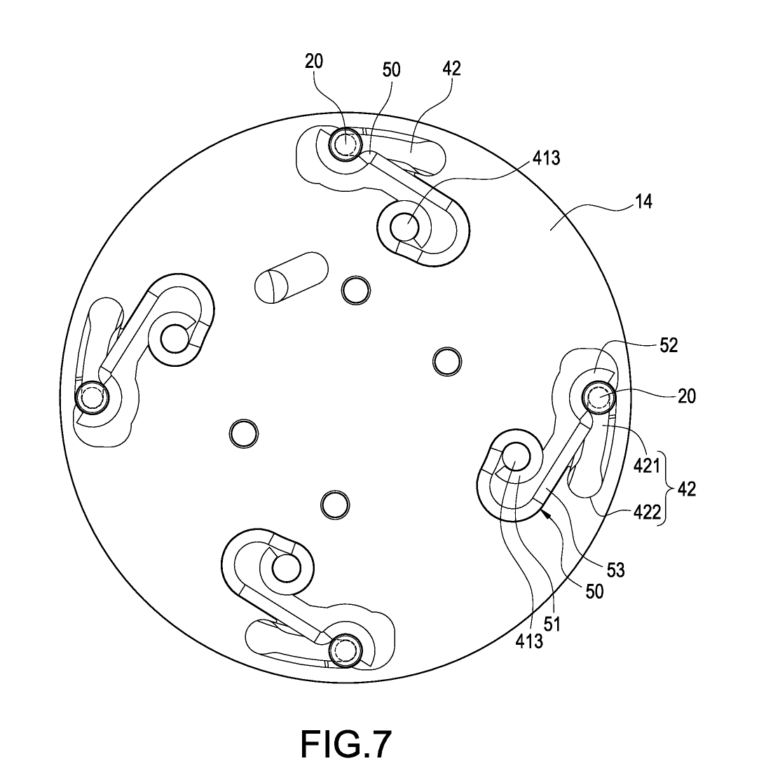

Please continue referring to FIGS. 6 and 7. They are schematic plan views of the LED lamp module of the present invention before and after assembly, respectively. During assembling, as shown in FIG. 6, first the metal fasteners 20 are aligned with the positions of the openings 42 and are inserted into the insertion holes 422 of the openings 42. Then, as shown in FIG. 7, the LED lamp base 10 is rotated and the metal fasteners 20 slide along the limit holes 421 of the openings 42 to approach the free ends of the flexible members 50. Finally, the LED lamp base 10 is rotated further and the metal fastener 20 slides through one side of the flexible member 50 to enter the hook segment 52. At this moment, the metal fasteners 20 are constrained by the hook segments 52 and positioned and thus, can not be moved outward. Therefore, the objective of quickly assembling the LED lamp base 10 and the heat sink 30 can be achieved.

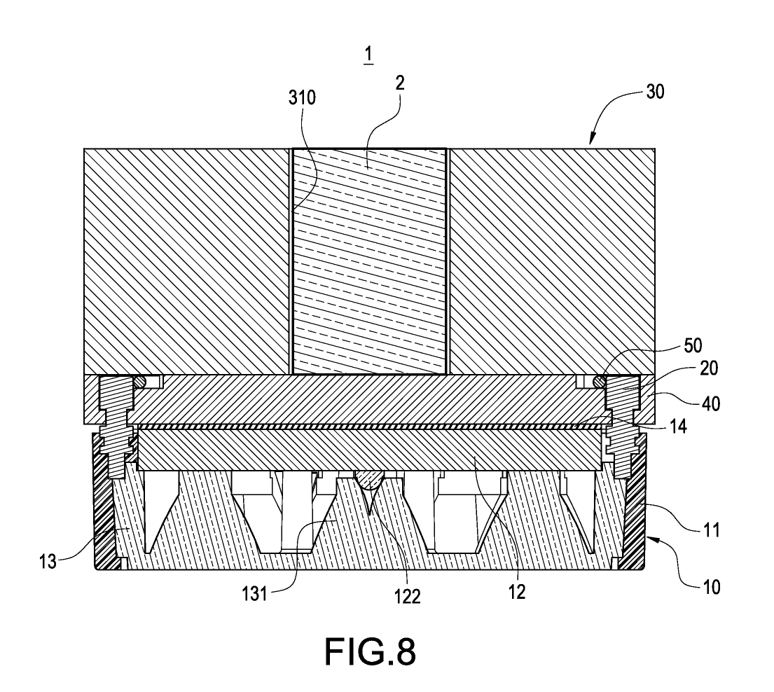

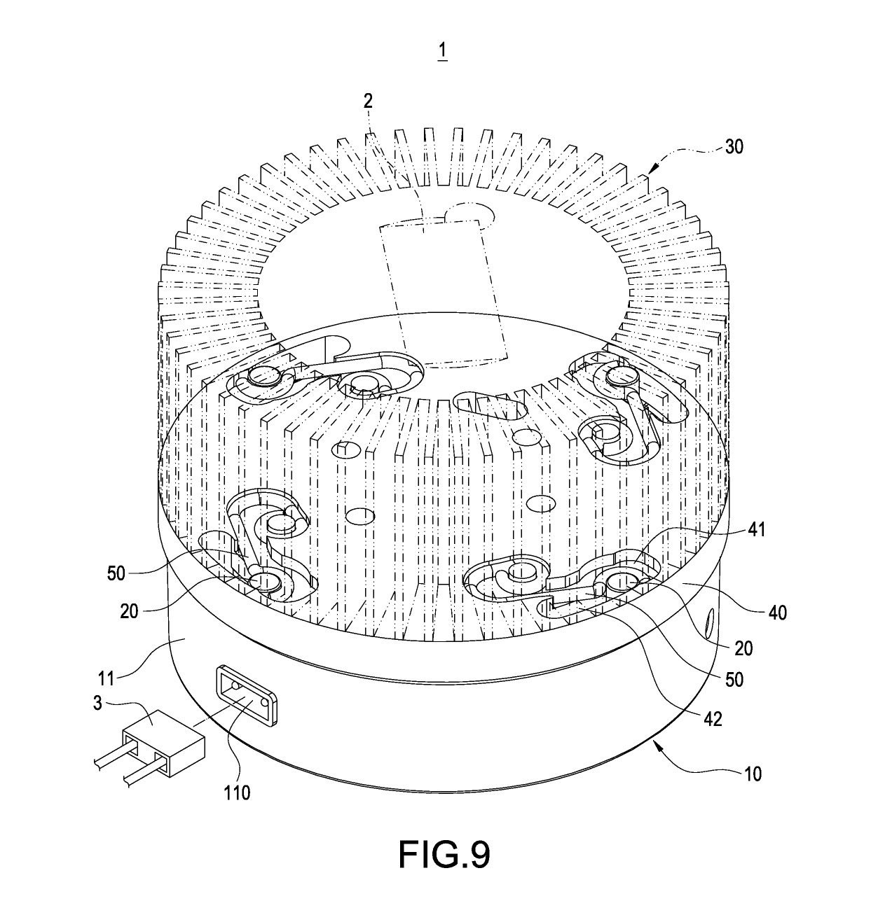

Please refer to FIGS. 8 and 9. They are a cross sectional side view and an external schematic view of the LED lamp module of the present invention after assembly, respectively. After the LED lamp module 1 of the present invention is assembled as described above, the LED lamp base 10 can be combined with the heat sink 30 at the bottom surface thereof by rotation. Similarly, if the LED lamp module 1 needs to be maintained, the LED lamp base 10 is simply rotated reversely and the metal fasteners 20 will be moved out of the hook segments 52. At this moment, the LED lamp base 10 can be separated from the heat sink 30.

It is worth noting that, in FIG. 9, there is an opening 110 formed on the outer surface of the plastic receptacle 11. A pair of conductive terminals of a plug 3 may be disposed in the opening 110 and the plug 3 is electrically connected to the pair of the conductive terminals to provide the power for the LED lamp module 1.

The embodiments described above are only the preferred embodiments of the present invention and are not to limit the scope of claims of present invention. Other equivalent variations applying the spirit of the present invention should be covered by the claims of the present invention.

What is claimed is:

1. An assembling structure of an LED lamp module, comprising:
an LED lamp base (10) comprising a plastic receptacle (11), an LED light source (12) disposed in the plastic receptacle (11), and a plurality of metal fasteners (20) spaced apart and upright on an outer side surface of the plastic receptacle (11); and
a heat sink (30) having a plurality of openings (42) ;
wherein the LED lamp base (10) is rotatable with respect to the heat sink (30) to make the metal fasteners (20) positioned in the openings (42), respectively, and thus the LED lamp base (10) is combined with the heat sink (30).

2. The assembling structure of an LED lamp module according to claim 1, further comprising a plurality of flexible members (50), the heat sink (30) comprising a positioning plate (40), the openings (42) formed on the positioning plate (40) and the positioning plate (40) further having a plurality of grooves (41) interconnected with the openings (42), the flexible members (50) being disposed in the respective grooves.

3. The assembling structure of an LED lamp module according to claim 2, wherein a projection (413) is disposed in each of the grooves (41), one end of the respective flexible member (50) is fastened at the projection (413), and the other end of the respective flexible member (50) is partially exposed to the respective openings (42) with a free state.

4. The assembling structure of an LED lamp module according to claim 3, wherein the flexible member (50) is a wire spring and comprises a ring segment (51) looped around the projection (413), a hook segment (52) constraining the metal fastener (20), and an extension segment (53) connecting the ring segment (51) and the hook segment (52).

5. The assembling structure of an LED lamp module according to claim 1, wherein the LED lamp base (10) further comprises a light diffuser (13) attached to the plastic receptacle (11), the diffuser (13) covers the LED light source (12), a plurality of light pipes (131) are formed on a side surface of the diffuser (13), and the side surface is facing the LED light source (12).

6. The assembling structure of an LED lamp module according to claim 1, wherein the heat sink (30) further comprises a thermal conductor (31) and the positioning plate (40) is combined with the thermal conductor (31).

7. The assembling structure of an LED lamp module according to claim 6, wherein the LED lamp base (10) further comprises an insulated plate (14) disposed on the side of the plastic receptacle (11) opposite to the light diffuser (13), the insulated plate (14) is disposed between the LED light source (12) and the positioning plate (40), the LED light source (12) has a wire (123), and the insulated plate (14) is provided with an aperture (140) through the aperture (140) the wire (123) is disposed.

8. The assembling structure of an LED lamp module according to claim 7, wherein the grooves (41) are disposed on a side surface of the positioning plate (40) and the side surface is attached to the thermal conductor (31), each of the grooves (41) has an inner end (411) adjacent to a center of the positioning plate (40) and an outer end (412) adjacent to and facing the perimeter of the positioning plate (40), and the openings (42) are connected to the outer ends (412) of the grooves and penetrate the positioning plate (40).

9. The assembling structure of an LED lamp module according to claim 7, wherein each of the openings (42) comprises a limit hole (421) connecting to the outer end of the respective grooves (41) and an insertion hole (422) disposed at the end of the limit hole (421), the limit hole (421) extending and shrinking from a side of the insertion hole (422) inwards.

10. The assembling structure of an LED lamp module according to claim 1, wherein the plastic receptacle (11) is a hollow ring and the metal fasteners (20) are disposed on the end surface of a side of the plastic receptacle (11) and the side is facing the heat sink (30).

11. The assembling structure of an LED lamp module according to claim 1, wherein each of the metal fasteners (20) comprises a support pin (21) fixed on the plastic receptacle (11) and a positioning rod (22) connecting to the end of the support pin (21), the support pin (21) being attached to the plastic receptacle (11) by insert-molding.

12. The assembling structure of an LED lamp module according to claim 1, wherein the heat sink (30) comprises a thermal conductor (31) and a plurality of fins (32) thermal-conductively connected to the thermal conductor (31) of cylinder shape, and the fins (32) are spaced apart on and surrounding the outer edge surface of the thermal conductor (31).
